(19) United States
(12) Patent Application Publication
(10) Pub. No.: US 2009/0316198 A1
(43) Pub. Date: Dec. 24, 2009

(54) PUBLICIZED INFORMATION BROWSING SUPPORT SYSTEM, PUBLICIZED INFORMATION BROWSING SUPPORT METHOD, AND COMPUTER-READABLE STORAGE MEDIUM FOR COMPUTER PROGRAM

(75) Inventors: Yasuji TAKEUCHI, Kobe-shi (JP); Tomoyuki Okamoto, Suita-shi (JP); Nobuo Kamei, Osaka-shi (JP); Tomo Tsuboi, Itami-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/485,287

(22) Filed: Jun. 16, 2009

(30) Foreign Application Priority Data
Jun. 20, 2008 (JP) 2008-161893

(51) Int. Cl. G06F 3/12

(52) U.S. Cl. 358/1.15

(57) ABSTRACT

A system receives a Web page and prints the same onto paper. Then, an image depicted on the paper is read. A written image that has been added to the paper after printing the Web page is obtained by comparing the Web page with the image. The latest version of the Web page is outputted together with the written image as required. A flag indicating whether or not a user has browsed the latest version is stored. Further, an update date/time of the Web page is received at every predetermined time. If the Web page has been outputted to the user, the flag of the user is updated to “already-read”. If the Web page is determined to have been updated based on the update date/time indicated in the received update date/time information, or if the written image has been obtained, all the flags are updated to “unread”.

This application is based on Japanese Patent Application No. 2008-161893 filed on Jun. 20, 2008, the contents of which are hereby incorporated by reference.

### BACKGROUND OF THE INVENTION

1. Field of the Invention

The present invention relates to a system, a method, and the like for handling attribute information, e.g., an RSS feed, including update date and time of information publicized on the Internet, and a summary thereof.

2. Description of the Related Art

WWW servers were initially used primarily for publicizing academic information. However, in recent years, such servers have been used to publicize information that has an updating frequency much higher than that of the academic information, such as news flashes, new product announcements, traffic information, weather information, weblogs, and so on.

Users tend to overlook information that is updated at high frequency. As a response to this, a technology called “RSS” has been proposed, such as those described in JP-2006-54732-A, JP-2007-148850-A and JP-2006-324918-A. According to the RSS technology, information such as the title, URL, summary, publicized date and time, and update date and time of a new Web page and an updated web page publicized on a network such as the Internet can be provided to users in the form of a list.

An application for implementing such a function is called, for example, an “RSS reader”, which is gradually coming into widespread use. Further, Multi-Function Peripherals (MFPs) including such an RSS reader have also been proposed.

Incidentally, a plurality of members of organizations such as businesses, public organizations or schools sometimes use an RSS reader. For example, employees of a company post, on their weblogs disclosed to each other, information associated in some way with the business and found on a television, a magazine or a Web site, which enables the employees to share new and useful information. In addition, if a list of Web pages disclosed only in a company, e.g., a business report, information about events such as a meeting, or an on-line manual, is written in RSS format, employees can easily find a newly-added Web page and an updated Web page, which is convenient for them.

In order to promote the spread and use of the RSS in organizations, an approach is necessary so that a plurality of members belonging thereto can share information efficiently using the RSS.

### SUMMARY

The present disclosure is directed to solve the problems pointed out above, and therefore, an object of an embodiment of the present invention is to promote the efficiency of a system and method for a case in which a plurality of members use the RSS to share information.

According to one aspect of the present invention, a publicized information browsing support system includes a publicized information receiving portion that receives publicized information that is publicized on a network and is to be updated thereon, a printer that prints, onto paper, a publicized information image representing the publicized information thus received, a reading portion that reads an image depicted on the paper, an obtaining portion that obtains a written image that has been added to the paper after printing the publicized information image by making a comparison between the publicized information image and the image thus read from the paper, an output portion that outputs to a user, as required, the publicized information image together with the written image, a storage portion that stores browsing presence/absence information indicating whether or not the user has browsed a latest version of the publicized information, a notification portion that notifies, based on the browsing presence/absence information, the user whether or not the user has browsed the latest version of the publicized information, an update date and time information receiving portion that receives, at every predetermined timing, update date and time information indicating an update date and time on which the publicized information has been updated, and an updating portion that updates, when the publicized information image has been outputted to the user, the browsing presence/absence information in such a manner to indicate that the user has browsed the latest version of the publicized information, and updates, when the publicized information is determined to have been updated based on the update date and time indicated in the update date and time information received by the update date and time information receiving portion, or when the written image has been obtained, the browsing presence/absence information in such a manner to indicate that the user has not browsed the latest version of the publicized information.

### BRIEF DESCRIPTION OF THE DRAWINGS

FIG. 1 is a diagram illustrating an example of the overall configuration of an information gathering/providing system, and an example of a topology of the information gathering/providing system and other devices.

FIG. 2 is a diagram illustrating an example of the hardware configuration of an information gathering server.

FIG. 3 is a diagram illustrating an example of the functional configuration of an information gathering server.

FIG. 4 is a diagram illustrating an example of the hardware configuration of an image forming apparatus.

FIG. 5 is a diagram illustrating an example of the functional configuration of an image forming apparatus.

FIG. 6 is a diagram illustrating an example of an aggregated feed table.

FIG. 7 is a diagram illustrating an example of a user browsing feed table.

FIG. 8 is a diagram illustrating an example of an RSS notification user setting screen.

FIG. 9 is a diagram illustrating an example of a WWW browser screen.

FIG. 10 is a flowchart illustrating an example of the flow of a browsing setting data registration process.

FIG. 11 is a diagram illustrating an example of an article attribute table.

FIG. 12 is a flowchart illustrating an example of the flow of an RSS feed aggregation process.

FIG. 13 is a flowchart illustrating an example of the flow of an RSS feed presenting process.

FIG. 14 is a diagram illustrating an example of a feed list screen.

FIG. 15 is a diagram illustrating an example of an article list screen.

FIG. 16 is a flowchart illustrating an example of the flow of an article output process.

FIG. 17 is a flowchart illustrating an example of the flow of a written article input process.

FIG. 18 is a flowchart illustrating an example of the flow of a written article registration process.

FIG. 19 is a flowchart illustrating an example of the overall processing flow of an information gathering/providing system.

### DESCRIPTION OF THE PREFERRED EMBODIMENTS

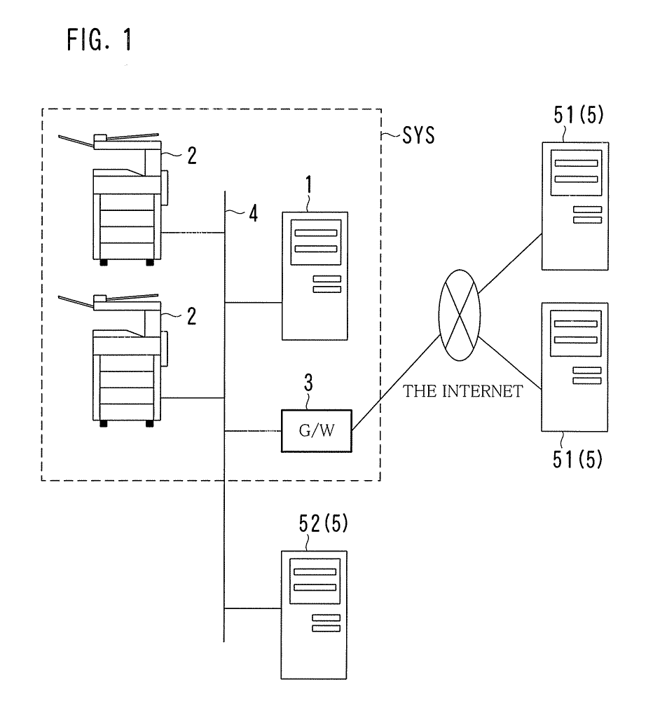

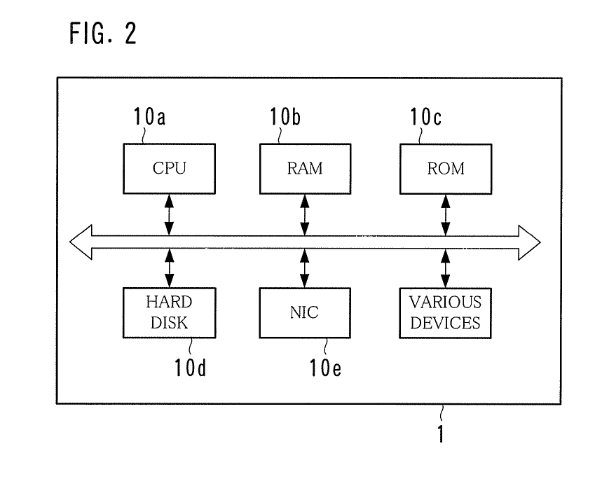

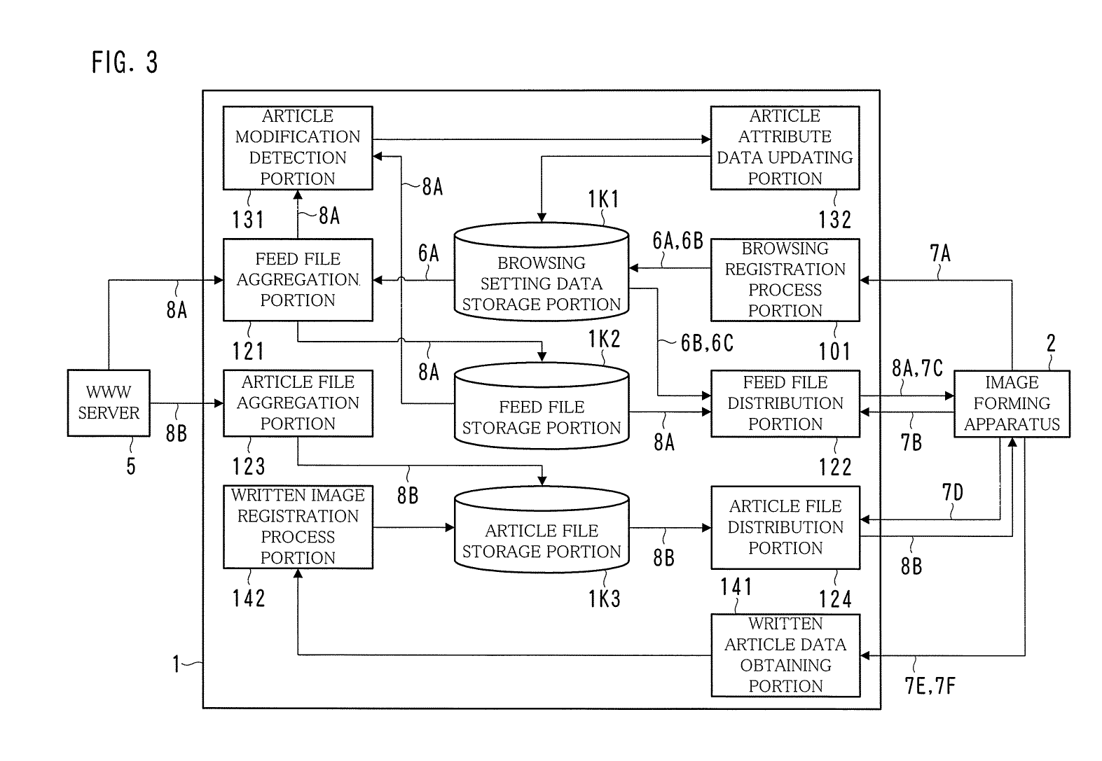

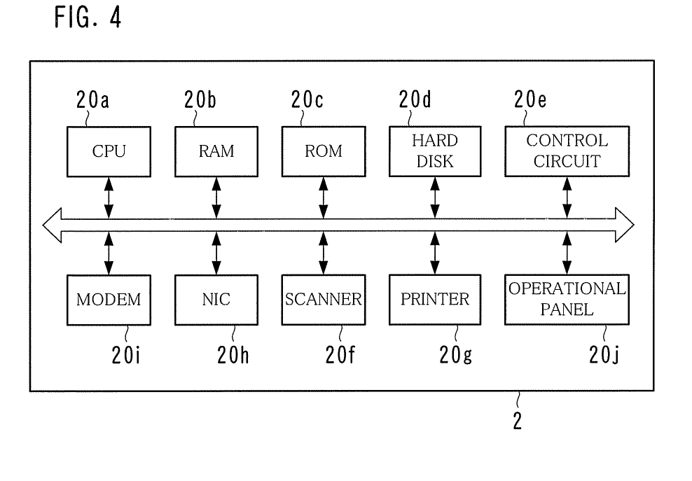

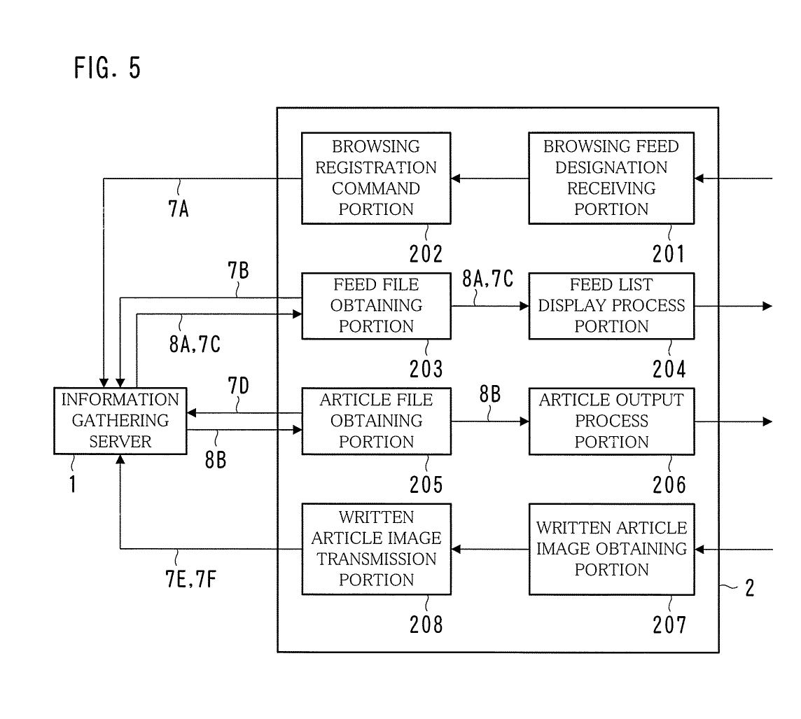

FIG. 1 is a diagram illustrating an example of the overall configuration of an information gathering/providing system SYS, and an example of a topology of the information gathering/providing system SYS and other devices; FIG. 2 is a diagram illustrating an example of the hardware configuration of an information gathering server 1; FIG. 3 is a diagram illustrating an example of the functional configuration of the information gathering server 1; FIG. 4 is a diagram illustrating an example of the hardware configuration of an image forming apparatus 2; and FIG. 5 is a diagram illustrating an example of the functional configuration of the image forming apparatus 2.

As illustrated in FIG. 1, the information gathering/providing system SYS corresponding to an embodiment of a publicized information browsing support system according to the present invention is configured of the information gathering server 1, one or more image forming apparatuses 2, a gateway 3, a communication line 4 and the like.

The information gathering/providing system SYS is installed in organizations such as businesses, public organizations or schools. The information gathering/providing system SYS checks information distributed from a sever on the Internet or a server on an intranet of such organizations, and aggregates new information for members of the organizations and provides them with the information thus aggregated.

The information gathering server 1, the image forming apparatuses 2 and the gateway 3 can be connected to one another via the communication line 4. A Local Area Network (LAN) line, a dedicated line, a public line or the like may be used as the communication line 4.

The gateway 3 is a device to connect the information gathering/providing system SYS to the Internet. A router, an access server, or the like may be used as the gateway 3. The information gathering server 1 and the image forming apparatuses 2 can communicate with a World Wide Web (WWW) server 51 on the Internet via the gateway 3.

Further, the information gathering/providing system SYS can be connected to a WWW server 52 on the intranet of the organization. The information gathering server 1 and the image forming apparatuses 2 can also communicate with the WWW server 52. Hereinafter, the WWW servers 51 and 52 are collectively referred to as a “WWW server 5”.

The WWW server 5 creates a Web site and distributes one or more Web pages on each of which an article is described. The WWW server 5 also provides data, written in RSS format (in other words, RSS data), of information such as the title (headline), summary, Uniform Resource Locator (URL), date and time on which an article is publicized, and date and time on which an article is updated the last time for each article. The article is sometimes called an “item”. RSS information including one or more items is sometimes called an “RSS feed”, or simply a “feed”.

There are slight format differences for RSS depending on the version thereof, and the unabbreviated name can also be “RDF Site Summary”, “Rich Site Summary”, or “Really Simple Syndication”, depending on the version. However, the information gathering server 1 and the image forming apparatuses 2 are compatible with any of the RSS versions.

The information gathering server 1 aggregates RSS data from RSS sites which individual members of an organization, i.e., individual users of the information gathering/providing system SYS are usually interested in, and centrally manages the RSS data thus aggregated. Further, the information gathering server 1 searches for an article that has been newly added or an article that has been updated. Then, when a user operates an image forming apparatus 2, the information gathering server 1 informs the image forming apparatus 2 that such an article has been found. Note that each user is given a user ID.

The image forming apparatus 2 is used for a user to browse (read) an article. The user can browse (read) an article by causing a touch panel of the image forming apparatus 2 to display the article or by printing the article onto paper.

Referring to FIG. 2, the information gathering server 1 is configured of a Central Processing Unit (CPU) 10a, a Random Access Memory (RAM) 10b, a Read Only Memory (ROM) 10c, a hard disk 10d, a Network Interface Card (NIC) 10e, and a variety of other devices.

The NIC 10e is an interface for communicating with the image forming apparatus 2, the WWW server 5, and the like using a protocol such as TCP/IP.

The ROM 10c and the hard disk 10d store programs and data for implementing, as shown in FIG. 3, a browsing registration process portion 101, a feed file aggregation portion 121, a feed file distribution portion 122, an article file aggregation portion 123, an article file distribution portion 124, an article modification detection portion 131, an article attribute data updating portion 132, a written article data obtaining portion 141, a written image registration process portion 142, a browsing setting data storage portion 1K1, a feed file storage portion 1K2, an article file storage portion 1K3, and so on.

These programs and data are loaded into the RAM 10b as necessary, whereupon the programs are executed by the CPU 10a. Thereby, processes performed by the individual portions described above and illustrated in the flowcharts discussed below are functionally implemented. A server machine or a workstation is used as the information gathering server 1.

The image forming apparatus 2 is a device that has a variety of functions, such as copying, PC printing, scanning, faxing, document server, and so on. Such apparatuses are sometimes called Multi-Function Peripherals (MFPs) or combination machines. Referring to FIG. 4, the image forming apparatus 2 is configured of a CPU 20a, a RAM 20b, a ROM 20c, a hard disk 20d, a control circuit 20e, a scanner 20f, a printer 20g, an NIC 20h, a modem 20i, an operational panel 20j, and the like.

The control circuit 20e is a circuit for controlling the hard disk 20d, the scanner 20f, the printer 20g, the NIC 20h, the modem 20i, the operational panel 20j, and so on.

The scanner 20f optically reads images of documents printed on paper, such as text, formulas, symbols, photographs, charts, illustrations, and the like, and creates image data thereof.

The printer 20g prints, onto paper, an image based on the image data obtained by the scanner 20f and an image based on image data transmitted from a personal computer or the information gathering server 1.

The NIC 20h is an interface for communicating with another device using a protocol such as TCP/IP. The modem 20i is an interface for communicating with a facsimile terminal based on a facsimile protocol via a public line.

The operational panel 20j is a touch panel that displays screens such as a screen for providing messages or instructions to a user, a screen for the user to input a type of process the user desires to be performed as well as processing conditions, a screen that displays the result of processes executed by the CPU 20a. The user can furthermore provide commands, specify processing conditions, and so on to the image forming apparatus 2 by touching the operational panel 20j.

The ROM 20c and the hard disk 20d store programs and data for implementing, as shown in FIG. 5, a browsing feed designation receiving portion 201, a browsing registration command portion 202, a feed file obtaining portion 203, a feed list display process portion 204, an article file obtaining portion 205, an article output process portion 206, a written article image obtaining portion 207, a written article image transmission portion 208, and so on. These programs and data are loaded into the RAM 20b as necessary, whereupon the programs are executed by the CPU 20a. Thereby, processes performed by the individual portions described above and illustrated in the flowcharts discussed below are functionally implemented. Some or all of the functions shown in FIG. 5 may be implemented by a circuit such as the control circuit 20e.

The following is a description of functions of the individual portions of the information gathering server 1 illustrated in FIG. 3 and of the individual portions of the image forming apparatus 2 illustrated in FIG. 5. The description is broadly divided into the following three parts: a function relating to browsing setting; a function to aggregate information and provide users with the information thus aggregated; and a function to provide information written by a user to other users.

### [Function Relating to Browsing Setting]

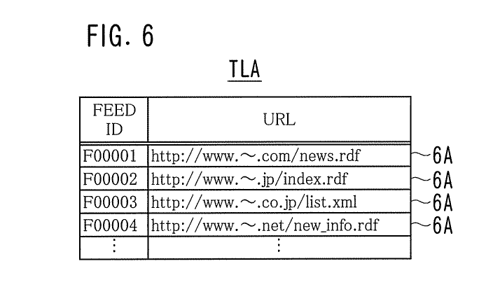

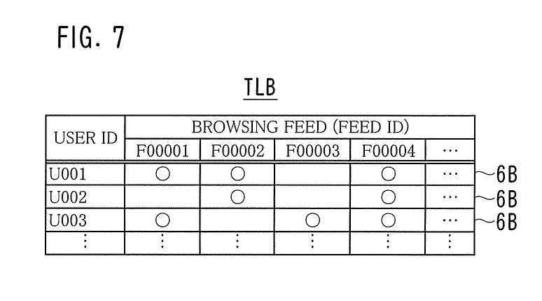

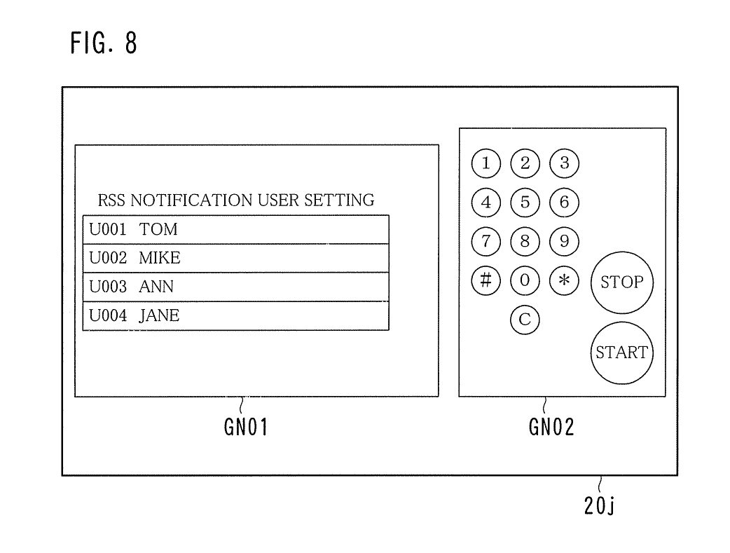

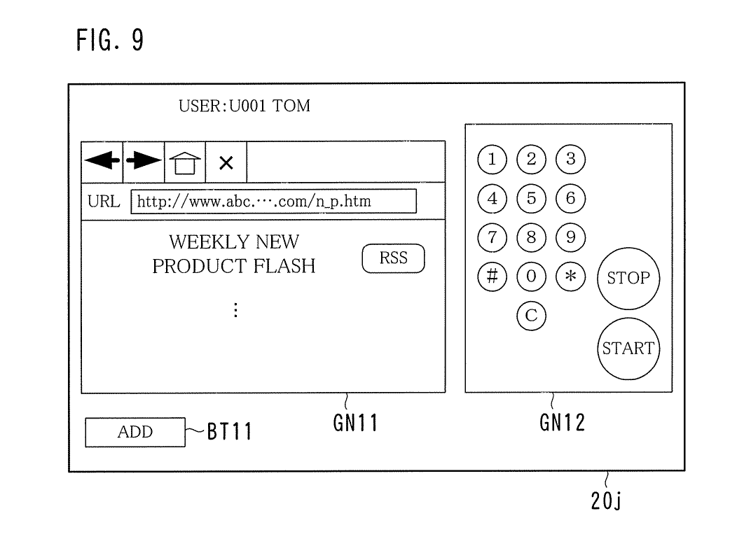

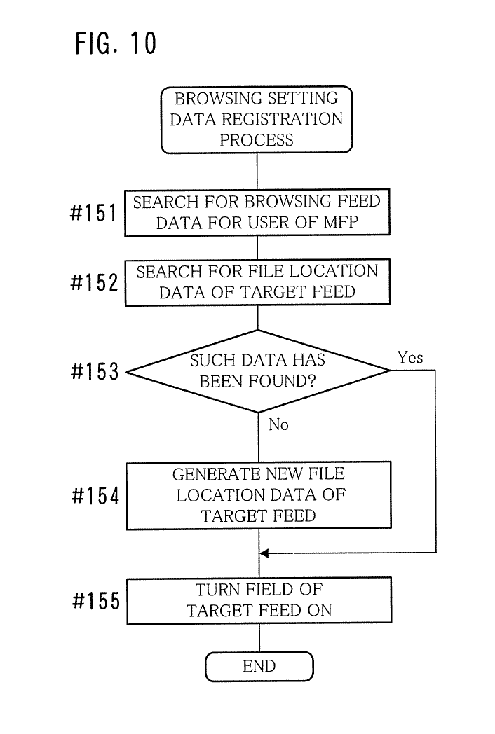

FIG. 6 is a diagram illustrating an example of an aggregated feed table TLA; FIG. 7 is a diagram illustrating an example of a user browsing feed table TLB; FIG. 8 is a diagram illustrating an example of an RSS notification user setting screen GN01; FIG. 9 is a diagram illustrating an example of a WWW browser screen GN11; and FIG. 10 is a flowchart illustrating an example of the flow of a browsing setting data registration process.

Every time a user logs onto an image forming apparatus 2, the image forming apparatus 2 can inform the user of an article that has been newly added to an RSS feed that he/she usually browses or an article that has been updated therein. In order to enjoy this service, data relating to browsing setting needs to be registered in advance in the information gathering server 1. This will be described in more detail below.

Referring to FIG. 3, the browsing setting data storage portion 1K1 of the information gathering server 1 stores and manages the aggregated feed table TLA, the user browsing feed table TLB, and an article attribute table TLC.

The aggregated feed table TLA stores file location data 6A for each RSS feed as illustrated in FIG. 6. The file location data 6A indicates a feed ID for distinguishing the corresponding RSS feed from the other RSS feeds, and an URL specifying the location, on a network, of a file of the corresponding RSS feed (RSS data).

The user browsing feed table TLB stores browsing feed data 6B for each user as illustrated in FIG. 7. The browsing feed data 6B includes a “user ID” field, and a “browsing feed” field for each RSS feed. A user ID of the user is indicated in the “user ID” field. Further, an open dot (◯) is indicated in a “browsing feed” field of an RSS feed that the user usually browses. A value of a “browsing feed” field of an RSS feed that the user does not usually browse is Null.

At a time when the operation of the information gathering server 1 is started, the aggregated feed table TLA has no file location data 6A therein. The browsing feed data 6B is prepared in advance on a user-by-user basis in the user browsing feed table TLB. The initial value of each “browsing feed” field in the browsing feed data 6B is Null.

The file location data 6A and the browsing feed data 6B are generated or updated, according to the following procedure, by the browsing registration process portion 101 of the information gathering server 1, the browsing feed designation receiving portion 201 and the browsing registration command portion 202 of the image forming apparatus 2 as illustrated in FIG. 5.

The browsing feed designation receiving portion 201 performs a process for causing a user to specify an RSS feed that the user desires to browse in the following manner.

The user operates the operational panel 20j to enter a predetermined command. Responding to this, as illustrated in FIG. 8, the browsing feed designation receiving portion 201 causes the operational panel 20j to display the RSS notification user setting screen GN01 and a common button screen GN02. The RSS notification user setting screen GN01 indicates a list of user IDs and names of individual users of the information gathering/providing system SYS. The user selects his/her user ID on the RSS notification user setting screen GN01 by pressing a line corresponding to his/her user ID.

Upon doing so, as illustrated in FIG. 9, the browsing feed designation receiving portion 201 causes the operational panel 20j to display, for example, the WWW browser screen GN11, a common button screen GN12, and an add button BT11. The user operates the WWW browser screen GN11 to surf the net and find a Web page (article) that is of interest to him/her. If the Web page has an icon of “RSS”, the user clicks the icon and presses the add button BT11.

In general, the “RSS” icon is associated with a URL of an RSS feed (RSS site) from which a summary of the Web page is distributed.

When the add button BT11 is pressed, the browsing feed designation receiving portion 201 receives an URL associated with the RSS icon.

The browsing registration command portion 202 transmits, to the information gathering server 1, browsing registration command data 7A including the URL received by the browsing feed designation receiving portion 201 and the user ID selected on the RSS notification user setting screen GN01 to instruct the information gathering server 1 to perform a registration process for browsing the RSS.

In the information gathering server 1, the browsing registration process portion 101 performs a process, for that user, for registering data relating to browsing setting of the RSS feed specified by the user according to the procedure illustrated in FIG. 10.

When receiving the browsing registration command data 7A, the browsing registration process portion 101 searches, in the user browsing feed table TLB (see FIG. 7), for browsing feed data 6B including the user ID indicated in the browsing registration command data 7A, i.e., including the user ID of the user of the image forming apparatus 2 (#151).

The browsing registration process portion 101 searches, in the aggregated feed table TLA (see FIG. 6), for file location data 6A including the URL indicated in the browsing registration command data 7A (#152).

If such file location data 6A is found (Yes in #153), then “browsing feed” fields of the browsing feed data 6B searched out in Step #151 are updated such that an open dot is shown in a “browsing feed” field for an RSS feed corresponding to a feed ID indicated in the file location data 6A thus found (#155).

In contrast, if such file location data 6A is not found (No in #153), then a new feed ID is issued and new file location data 6A including the new feed ID and the URL indicated in the browsing registration command data 7A is generated and then stored in the aggregated feed table TLA (#154). In short, file location data 6A of an RSS feed provided on the URL indicated in the browsing registration command data 7A is newly registered. Then, a “browsing feed” field for the RSS feed corresponding to the feed ID of the new file location data 6A thus generated is appropriately added to the corresponding browsing feed data 6B, and an open dot is set as the value of the “browsing feed” field thus added (#155).

[Function to Aggregate Information and Provide Users with the Aggregated Information]

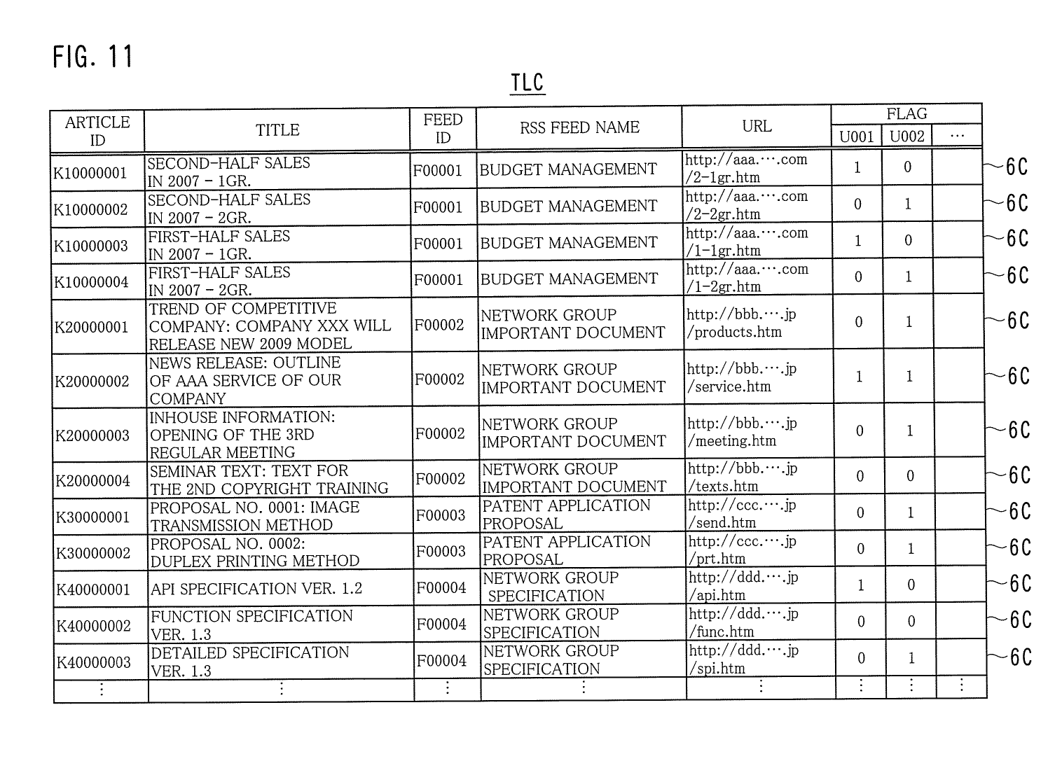

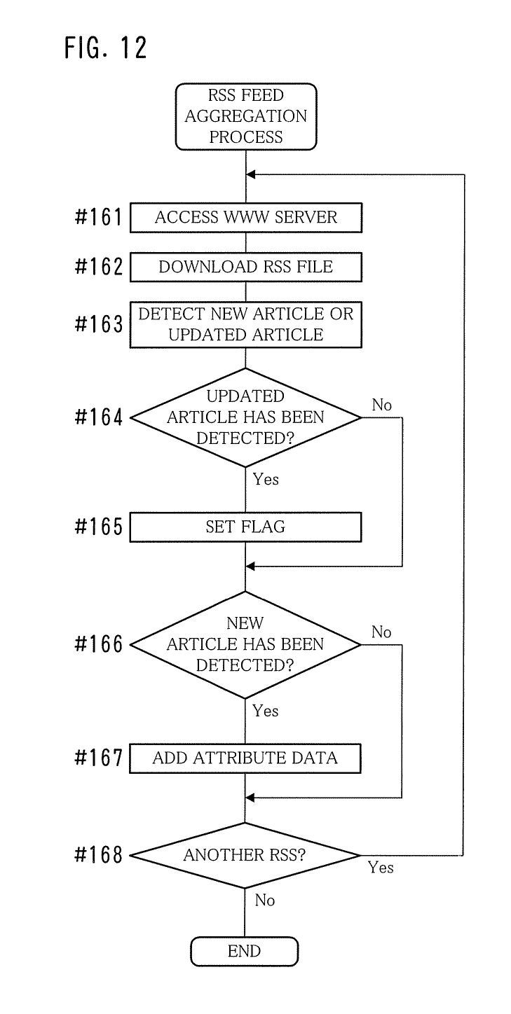

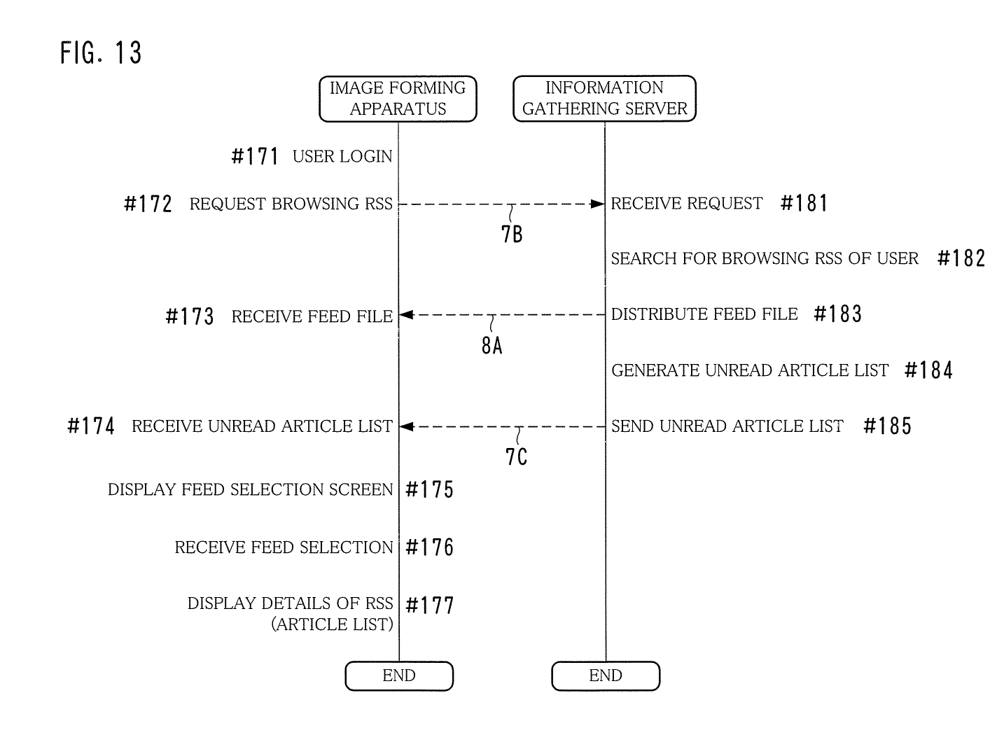

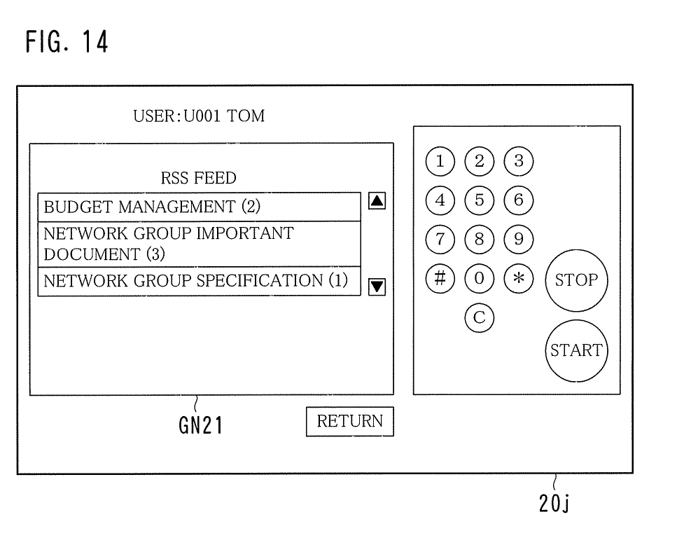

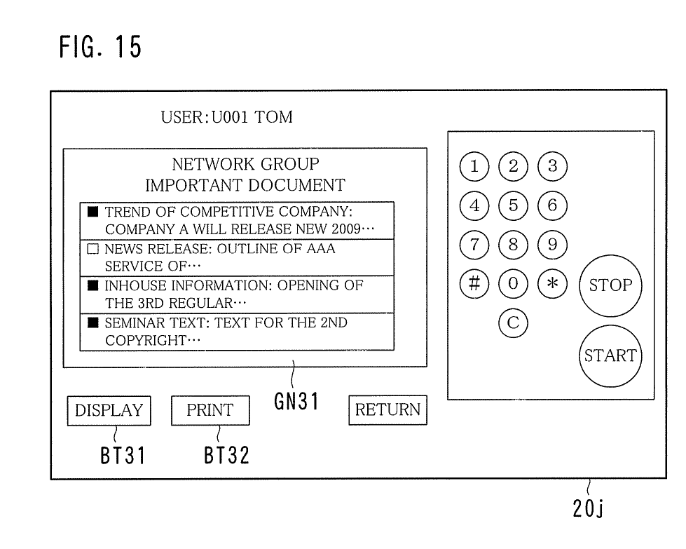

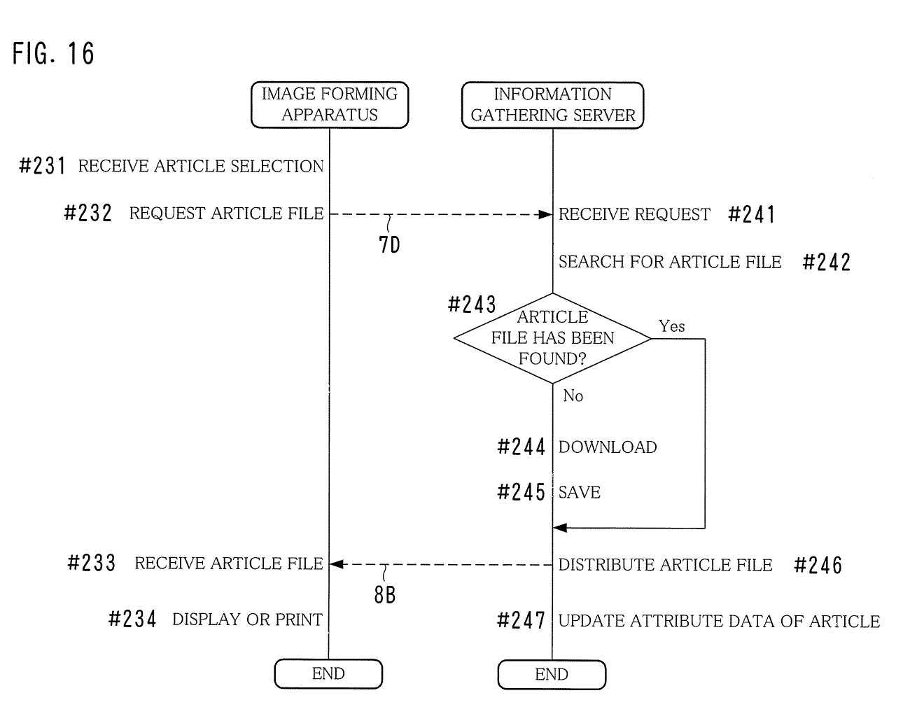

FIG. 11 is a diagram illustrating an example of the article attribute table TLC; FIG. 12 is a flowchart illustrating an example of the flow of an RSS feed aggregation process; FIG. 13 is a flowchart illustrating an example of the flow of an RSS feed presenting process; FIG. 14 is a diagram illustrating an example of a feed list screen GN21; FIG. 15 is a diagram illustrating an example of an article list screen GN31; and FIG. 16 is a flowchart illustrating an example of the flow of an article output process.

The following portions of the information gathering server 1 and the image forming apparatus 2 perform a process for aggregating RSS feeds and articles to enable users to browse the same: the feed file aggregation portion 121, the feed file distribution portion 122, the article file aggregation portion 123, the article file distribution portion 124, the article modification detection portion 131, the article attribute data updating portion 132, the feed file obtaining portion 203, the feed list display process portion 204, the article file obtaining portion 205, and the article output process portion 206.

The feed file aggregation portion 121 of the information gathering server 1 downloads an RSS feed file (hereinafter referred to as a “feed file 8A”) from the WWW server 5 at a predetermined timing, e.g., when a predetermined time comes.

Incidentally, the feed file 8A downloaded by the feed file aggregation portion 121 indicates a variety of information for each article. To be more specific, as described earlier, the feed file 8A indicates information such as the title and summary of an article, an URL of a web page on which the article is described, date and time at which the article is publicized, and date and time at which the article is updated the last time.

The feed file storage portion 1K2 stores therein the article attribute table TLC as illustrated in FIG. 11, which stores attribute data 6C for each article indicated in the feed file 8A thus downloaded.

The article modification detection portion 131 detects a new article and an updated article from the feed file 8A. The article attribute data updating portion 132 newly generates attribute data 6C of the new article and adds the attribute data 6C thus generated to the article attribute table TLC. The article attribute data updating portion 132 also updates attribute data 6C of the updated article.

The following is a description of a process for downloading a feed file 8A, a process for generating and updating attribute data 6C, and the details of attribute data 6C with reference to the flowchart shown in FIG. 12.

The feed file aggregation portion 121 accesses the WWW server 5 (#161) based on the URL indicated in the file location data 6A stored as the first data in the aggregated feed table TLA (see FIG. 6) to download a feed file 8A (#162).

The feed file 8A thus downloaded is associated with the feed ID of the corresponding RSS feed and is stored in the feed file storage portion 1K2. As described earlier, a feed file 8A is periodically downloaded from the WWW server 5 based on the identical URL. The feed file storage portion 1K2 is caused to store a latest feed file 8A among the feed files 8A downloaded from the WWW server 5 based on the identical URL. Stated differently, an older feed file 8A is deleted from the feed file storage portion 1K2.

If a feed file 8A is downloaded based on a URL for the first time, all articles (items) indicated in the feed file 8A are new articles (items) for users of the information gathering/providing system SYS. In such a case, the article modification detection portion 131 detects, as new articles, all the articles indicated in the feed file 8A (#163, No in #164, and Yes in #166). Then, the article attribute data updating portion 132 issues an article ID for each of the articles, generates attribute data 6C for each of the articles, and stores a plurality of pieces of the attribute data 6C thus generated in the article attribute table TLC (#167).

The attribute data 6C has the following fields, and the following information is indicated therein. The “article ID” field indicates an article ID issued for the corresponding article. The “title” and “RSS feed name” fields, respectively, indicate a title of the corresponding article and a title of the corresponding RSS feed specified in the feed file 8A. The “feed ID” and “URL” fields indicate a feed ID and a URL respectively included in the file location data 6A.

The attribute data 6C also has a “flag” field for each user. The flag is so-called an unread flag. In the case where a user has not yet browsed an article since the article was added or updated, the value of “1” meaning that the article is unread is indicated in the “flag” field for the user. In the case where the user has already browsed an article since then, the value of “0” meaning that the article is already read is indicated in the “flag” field for the user. The initial values of flags of the individual users are set to “1” in the attribute data 6C.

On the other hand, if download was performed previously based on the identical URL, then the article modification detection portion 131 detects a modification to the article in accordance with the feed file 8A downloaded this time, and the date and time on which download was performed previously based on the identical URL (#163).

To be more specific, if the update date and time of an article is newer than the date and time on which download was performed previously, and besides, if the publicized date and time of the article is older than the date and time on which download was performed previously, then the article modification detection portion 131 detects the article as an updated article. If so (Yes in #164), the article attribute data updating portion 132 searches for attribute data 6C of the article, based on the URL of the article and a feed ID associated with the feed file 8A. Then, the article attribute data updating portion 132 updates the value of the flags of the individual users indicated in the attribute data 6C to “1” (#165). Alternatively, the article modification detection portion 131 detects, as an updated article, an article in which the update date and time indicated in the feed file 8A downloaded this time is different from the update date and time indicated in the feed file 8A downloaded previously.

Further, if the publicized date and time of an article is newer than the date and time on which download was performed previously, then the article modification detection portion 131 detects the article as a new article. If this is the case (Yes in #166), then the article attribute data updating portion 132 issues a new article ID, newly generates attribute data 6C of the new article, and stores the attribute data 6C thus generated in the article attribute table TLC (#167). The initial values of the individual fields of the attribute data 6C are described earlier.

In the case where a user makes a note on a printed material of an article, attribute data 6C of the article is updated. This will be described later.

The processing steps described with reference to FIG. 12 are performed also on the second and later file location data 6A stored in the aggregated feed table TLA.

Referring back to FIGS. 3 and 5, when a user logs onto the image forming apparatus 2, the feed file obtaining portion 203 of that image forming apparatus 2 obtains, from the information gathering server 1, a feed file 8A of RSS feeds that the user usually browses. The feed list display process portion 204 performs a process for displaying a list of the RSS feeds for the user. The feed file distribution portion 122 of the information gathering server 1 performs a process for distributing the feed file 8A requested by the image forming apparatus 2.

The following is a description of processing steps of the feed file distribution portion 122, the feed file obtaining portion 203, and the feed list display process portion 204 with reference to the flowchart shown in FIG. 13, taking an example of a case in which a user Ux operates the image forming apparatus 2.

When the user Ux logs onto the image forming apparatus 2 using his/her user ID (#171 in FIG. 13), the feed file obtaining portion 203 transmits, to the information gathering server 1, feed request data 7B indicating the user ID of the user Ux to request a feed file 8A (#172).

When the feed request data 7B is received in the information gathering server 1 (#181), the feed file distribution portion 122 retrieves browsing feed data 6B including the user ID indicated in the feed request data 7B from the user browsing feed table TLB (see FIG. 7), and searches for feed IDs of RSS feeds in each of which an open dot is indicated in the browsing feed data 6B (#182). Then, the feed file distribution portion 122 distributes (transmits), to the image forming apparatus 2 that is the request source, the feed files 8A that are stored in the feed file storage portion 1K2 in association with the feed IDs thus searched (#183).

Further, in parallel with the transmission of the feed files 8A or before or after the transmission of the feed files 8A, the feed file distribution portion 122 searches for articles that have not yet been read by the user Ux among articles included in the RSS feeds in which an open dot is indicated, and generates unread article list data 7C indicating a list of the articles thus searched (#184). After that, the feed file distribution portion 122 transmits the unread article list data 7C to the image forming apparatus 2 (#185). The unread article list data 7C can be generated in the following manner.

A plurality of pieces of attribute data 6C indicating the feed IDs obtained as a result of Step #182 are retrieved from the article attribute table TLC (refer to FIG. 11). Then, attribute data 6C in which the flag of the user Ux is set to “1” is selected from among the plurality of pieces of attribute data 6C thus retrieved. Thereafter, unread article list data 7C indicating an article ID and a URL included in the attribute data 6C thus selected is generated.

With the image forming apparatus 2, when the feed file obtaining portion 203 receives the feed files 8A and the unread article list data 7C (#173 and #174), the feed list display process portion 204 causes the operational panel 20j to display the feed list screen GN21 (refer to FIG. 14) based on the feed files 8A and the unread article list data 7C (#175).

The feed list screen GN21 displays a list of RSS feeds for which the user Ux registers in the information gathering server 1 in order to browse articles included in the RSS feeds. Names such as “budget management” shown in the feed list screen GN21 are based on the names of the RSS feeds included in the feed files 8A received from the information gathering server 1. A numeral in parentheses such as (2) is added to the end of the individual RSS feed names. The numeral is the number of articles that have not yet been read by the user Ux among articles included in the corresponding RSS feed. The number can be derived by counting the number of articles included in the individual RSS feeds indicated in the unread article list data 7C.

When the user Ux presses a line corresponding to any of RSS feeds on the feed list screen GN21 to select the RSS feed, the feed list display process portion 204 receives the details of the selection (#176), and causes the operational panel 20j to display the article list screen GN31, a display button BT31, and a print button BT32 as shown in FIG. 15 (#177).

The article list screen GN31 displays a list of articles included in the RSS feed selected by the user Ux. Titles of the individual articles are based on the feed file 8A of the corresponding RSS feed. Any one of a solid black square and a white square is added to the beginning of each title. The solid black square means that the user Ux has already browsed the corresponding article, while the white square means that the user Ux has not yet browsed the corresponding article. The unread article list data 7C shows whether or not an article has already been browsed.

Referring back to FIGS. 3 and 5, the article file obtaining portion 205 of the image forming apparatus 2 obtains, from the information gathering server 1, files necessary for reproducing images of the article selected by the user Ux on the article list screen GN31. The examples of such files are an HTML file written in HTML, and an image file contained therein. Hereinafter, such a file is referred to as an “article file 8B”. The article output process portion 206 performs an output process of the article selected by the user Ux by displaying the article on the operational panel 20j or printing the article onto paper. The article file aggregation portion 123 of the information gathering server 1 aggregates, from the WWW server 5, the article file 8B requested by the image forming apparatus 2. The article file distribution portion 124 distributes the article file 8B thus requested to the image forming apparatus 2. The article attribute data updating portion 132 updates attribute data 6C of the article selected by the user Ux.

The following is a description of processing steps of the article file obtaining portion 205, the article output process portion 206, the article file aggregation portion 123, the article file distribution portion 124, and the article attribute data updating portion 132 with reference to the flowchart shown in FIG. 16, taking an example of a case in which the user Ux operates the image forming apparatus 2.

When receiving the selection of the article made by the user Ux, and the selection of any one of the display button BT31 and the print button BT32 made by the user Ux (#231), the article file obtaining portion 205 of the image forming apparatus 2 transmits, to the information gathering server 1, article request data 7D including an article ID of the article selected by the user Ux to request an article file 8B corresponding to the selected article (#232).

With the information gathering server 1, when the article request data 7D is received (#241), in principle, the article file aggregation portion 123 retrieves, from the article attribute table TLC (refer to FIG. 11), attribute data 6C including the article ID indicated in the article request data 7D thus received, and downloads, from the WWW server 5, the article file 8B corresponding to the requested article based on the URL included in the attribute data 6C (#244). The article file aggregation portion 123 associates the article file 8B with the article ID and the date and time at which the article file 8B has been downloaded (acquired) (hereinafter, the date and time is referred to as the acquisition date and time), and then, causes the article file storage portion 1K3 to store the resultant (#245). The article file distribution portion 124 distributes the article file 8B to the image forming apparatus 2 that made the request for the article (#246). At this time, the article file distribution portion 124 informs the image forming apparatus 2 of the article ID of the article and the acquisition date and time of the article file 8B.

Suppose that an article file 8B associated with the article ID has been already stored in the article file storage portion 1K3, and further, the requested article has ever been updated. In such a case, if the acquisition date and time of the article file 8B is newer than the last update date and time of the article (Yes in #243), then the article file aggregation portion 123 does not download the article file 8B, and the article file distribution portion 124 transmits the article file 8B to the image forming apparatus 2 (#246). As with the case described above, the article file distribution portion 124 informs the image forming apparatus 2 of the article ID of the article and the acquisition date and time of the article file 8B. If a plurality of article files 8B corresponding to the article ID are found, the article file distribution portion 124 distributes one of the article files 8B having the latest acquisition date and time.

The article attribute data updating portion 132 updates the flag of the user Ux included in the attribute data 6C of the article to “0” (#247).

With the image forming apparatus 2, when the article file obtaining portion 205 obtains (receives) the article file 8B (#233), the article output process portion 206 outputs the details of the article based on the article file 8B (#234). If the user Ux selects the display button BT31 on the article list screen GN31, then the article output process portion 206 causes the operational panel 20j to display the details of the article. On the other hand, if the user Ux selects the print button BT32 on the article list screen GN31, then the article output process portion 206 controls the printer 20g to print the article onto paper. Note that the article output process portion 206 causes the printer 20g to print, together with the details of the article, the article ID and the acquisition date and time received from the information gathering server 1.

### [Function to Provide Information Written by a User to Other Users]

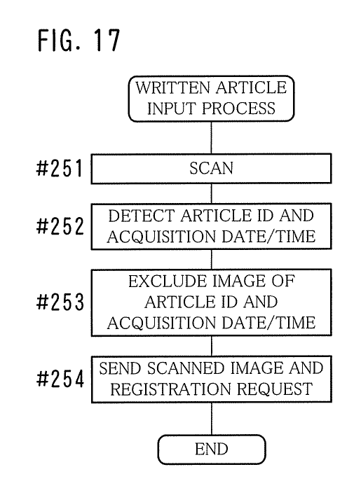

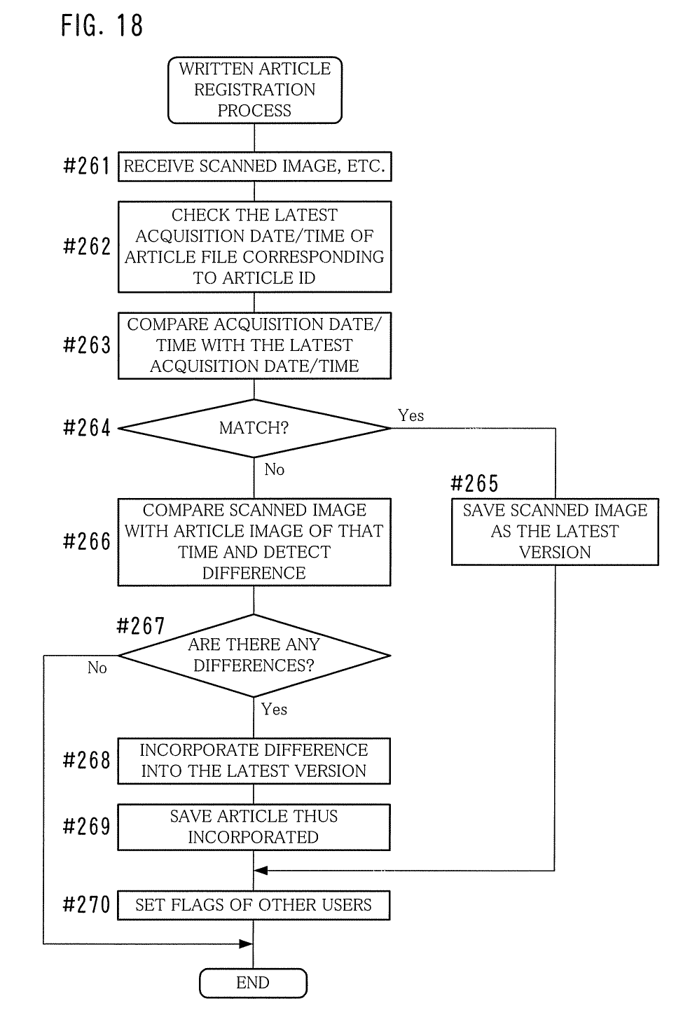

FIG. 17 is a flowchart illustrating an example of the flow of a written article input process; and FIG. 18 is a flowchart illustrating an example of the flow of a written article registration process.

A user can make a note on a printed material of an article. Then, the article with which the note is merged can be browsed by other users.

The written article data obtaining portion 141 and the written image registration process portion 142 of the information gathering server 1, and the written article image obtaining portion 207 and the written article image transmission portion 208 of the image forming apparatus 2 perform a process for preparing an article with which a note is merged. The following is a description of procedures of the process with reference to FIGS. 17 and 18, taking an example of a case in which the user Ux operates the image forming apparatus 2.

The user Ux logs onto the image forming apparatus 2 using his/her user ID. Then, the user Ux places, on a document tray of the image forming apparatus 2, a printed material of an article to which a note is added, and enters a predetermined command.

Responding to this, the written article image obtaining portion 207 of the image forming apparatus 2 causes the scanner 20f to scan the printed surface of the printed material, thereby to obtain image data of an image of the article to which a note is added (#251 in FIG. 17). The written article image obtaining portion 207 detects an image showing an article ID and the acquisition date and time on the image read out by the scanner 20f (hereinafter, referred to as a “scanned image”), and obtains text data of the article ID and the acquisition date and time through an Optical Character Reader (OCR) process (#252). After that, the image showing the article ID and the acquisition date and time is excluded from the scanned image (#253).

The written article image transmission portion 208 transmits, to the information gathering server 1, image data 7E of the scanned image with the image showing the article ID and the acquisition date and time excluded, and registration request data 7F including the detected article ID and the acquisition date and time, and the user ID of the user Ux (#254).

In the information gathering server 1, when the written article data obtaining portion 141 receives (obtains) the image data 7E and the registration request data 7F (#261 in FIG. 18), the written image registration process portion 142 performs a process for registering an article file 8B of the article to which a note is added in the following manner.

The written image registration process portion 142 checks the acquisition date and time of an article file 8B stored in the article file storage portion 1K3 in association with the article ID included in the registration request data 7F (#262). If a plurality of such article files 8B are stored, then the written image registration process portion 142 checks the latest acquisition date and time. The acquisition date and time indicated in the registration request data 7F is compared with the latest acquisition date and time thus checked (#263).

If there is a match between the acquisition date and time indicated in the registration request data 7F and the latest acquisition date and time (Yes in #264), then it is determined that an image reproduced based on the image data 7E is an image corresponding to an article that has been recently downloaded from the WWW server 5 and a note is added thereon, i.e., by making a note on the latest article. The written image registration process portion 142 causes the article file storage portion 1K3 to store the image data 7E as an article file 8B (#265). At this time, the article file 8B is associated with, as the acquisition date and time, date and time at which the image data 7E has been received (obtained) from the image forming apparatus 2, and is also associated with the article ID included in the registration request data 7F.

On the other hand, if there is no match between the acquisition date and time indicated in the registration request data 7F and the latest acquisition date and time (No in #264), then it is determined that an image reproduced based on the image data 7E is an image corresponding to an article that was downloaded from the WWW server 5 and a note is added thereon, i.e., by making a note on an article that is not the latest article. The written image registration process portion 142 causes the article file storage portion 1K3 to register image data of an article obtained by merging a note with the latest article.

In short, the written image registration process portion 142 compares an image reproduced based on the image data 7E with an image of a version of an article on which a note is made, and detects a difference therebetween (#266). This makes it possible to extract an image of the note and to detect a position thereof.

Note that the image of a version of the article on which a note is made can be reproduced based on the article file 8B that is stored in the article file storage portion 1K3 in association with the article ID and the acquisition date and time included in the registration request data 7F.

After detecting the difference as described above, that is, after extracting the image of the note (Yes in #267), the image of the note is incorporated into the image of the latest version of that article by overlapping the former onto the latter (#268). Then, the written image registration process portion 142 causes the article file storage portion 1K3 to store, as an article file 8B, image data of the resultant image, i.e., the overlapped image (#269). At this time, the article file 8B is associated with, as the acquisition date and time, the date and time at which the overlapped image has been generated, and is also associated with the article ID included in the registration request data 7F.

The details of the note have probably not yet been browsed by users other than the user Ux. In view of this, after the article file 8B has been newly stored in the article file storage portion 1K3 in Step #265 or Step #269, the article attribute data updating portion 132 updates flags of individual users other than the user Ux included in the attribute data 6C (refer to FIG. 11) corresponding to that article to “1” (#270).

Through the processes described above, preparation for allowing users other than the user Ux to browse the note is completed. Thereafter, if a user other than the user Ux logs onto the image forming apparatus 2, and at the same time, if that user usually browses an RSS feed including the article, then that user is informed that the article has been updated, as shown in FIG. 15, through the processes described earlier with reference to FIGS. 12 and 13. Then, the article is outputted for that user through the processes described earlier with reference to FIG. 16.

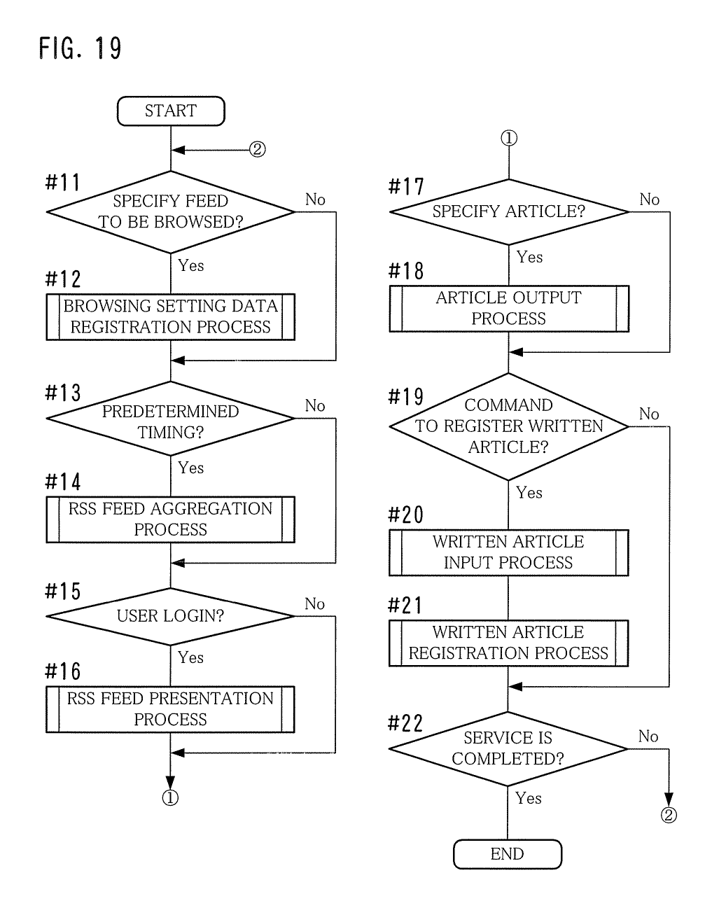

FIG. 19 is a flowchart illustrating an example of the overall processing flow of the information gathering/providing system SYS.

The following is a description of the overall processing flow of the information gathering/providing system SYS for providing a user with an RSS feed and an article with reference to the flowchart illustrated in FIG. 19.

Every time some event occurs, the information gathering server 1 and the image forming apparatus 2 perform the following processing.

A user specifies an RSS feed that he/she intends to browse often in the future (Yes in #11 of FIG. 19). Responding to this, the image forming apparatus 2 transmits, to the information gathering server 1, browsing registration command data 7A including a user ID of the user and a URL of the specified RSS feed, and the information gathering server 1 performs, for the user, a process for registering data relating to browsing setting of the RSS feed based on the browsing registration command data 7A (#12). The detailed processing is described earlier with reference to FIG. 10.

Alternatively, at a predetermined timing, e.g., when a predetermined time comes (Yes in #13), the information gathering server 1 performs a process for aggregating RSS feeds that any of the users usually browses from each WWW server 5 (#14). The detailed processing is described earlier with reference to FIG. 12.

Further alternatively, when a user logs onto the image forming apparatus 2 (Yes in #15), the information gathering server 1 and the image forming apparatus 2 perform a process for presenting, to the user, a list of RSS feeds that the user usually browses and a list of articles of the individual RSS feeds (#16). The detailed processing is described earlier with reference to FIG. 13.

Further alternatively, when the user specifies any of the articles and issues a command to display or print the article thus specified (Yes in #17), the information gathering server 1 and the image forming apparatus 2 perform a process for displaying or printing the latest version of the article (#18). The detailed processing is described earlier with reference to FIG. 16.

Still further alternatively, when the user makes a note on a printed material of an article, and then, issues a command to register the article to which the note is added (Yes in #19), the image forming apparatus 2 performs a process for reading an image depicted on the printed material (#20), and the information gathering server 1 performs a process for registering the image thus read (#21). The detailed processing is described earlier with reference to FIGS. 17 and 18.

The processing from Step #11 through Step #21 is performed as appropriate while the information gathering server 1 and/or the image forming apparatus 2 operate.

This embodiment makes it possible to promote the efficiency of a system and method when a plurality of users share information by using the RSS technology.

More specifically, the information gathering/providing system SYS obtains an RSS feed at regular intervals even when one user browses the RSS feed or even when a plurality of users browse the RSS feed. Thus, the redundancy of reception of RSS feeds is reduced, making it possible to promote the efficiency of reception processes.

If a user makes a note on an article, the information gathering/providing system SYS informs other users that the article has been updated. Thus, users can efficiently share even information such as a note.

In this embodiment, the information gathering/providing system SYS is configured of a single information gathering server 1, one or more image forming apparatuses 2, and the like. Instead, however, another configuration is possible in which a single image forming apparatus (MFP) integrates, into a single unit, the functions of the information gathering server 1 as shown in FIG. 3 and the functions of the image forming apparatus 2 as shown in FIG. 5.

Alternatively, instead of the image forming apparatus 2, a personal computer, a printer or a scanner can be used. The printer or the scanner may be a printer or a scanner of the type which connects to a personal computer via a Universal Serial Bus (USB) port, a printer port, an RS-232C port, or the like. Alternatively, it may be a printer or a scanner of the type which is shared by a plurality of personal computers via an NIC.

In some cases, after a written image such as an image of a note has been overlapped onto an article, the article is updated on the WWW server 5. Thereafter, the information gathering server 1 downloads an article file 8B of the latest version of the article. Image data of the written image may be stored in association with an article ID of the article in order to reflect the written image in the latest version of the article. Then, after downloading the article file 8B of the latest version of the article, the information gathering server 1 may overwrite the article file 8B such that the written image is overlapped onto the image of that article.

In the embodiments discussed above, the overall configuration of the information gathering/providing system SYS, the information gathering server 1, and the image forming apparatus 2, the configurations of various portions thereof, the content to be processed, the processing order, the details of the various pieces of data, the details of the various files and the like may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A publicized information browsing support system comprising:
a publicized information receiving portion that receives publicized information that is publicized on a network and is to be updated thereon;
a printer that prints, onto paper, a publicized information image representing the publicized information thus received;
a reading portion that reads an image depicted on the paper;
an obtaining portion that obtains a written image that has been added to the paper after printing the publicized information image by making a comparison between the publicized information image and the image thus read from the paper;
an output portion that outputs to a user, as required, the publicized information image together with the written image;
a storage portion that stores browsing presence/absence information indicating whether or not the user has browsed a latest version of the publicized information;
a notification portion that notifies, based on the browsing presence/absence information, the user whether or not the user has browsed the latest version of the publicized information;
an update date and time information receiving portion that receives, at every predetermined timing, update date and time information indicating an update date and time on which the publicized information has been updated; and
an updating portion that updates, when the publicized information image has been outputted to the user, the browsing presence/absence information in such a manner to indicate that the user has browsed the latest version of the publicized information, and updates, when the publicized information is determined to have been updated based on the update date and time indicated in the update date and time information received by the update date and time information receiving portion, or when the written image has been obtained, the browsing presence/absence information in such a manner to indicate that the user has not browsed the latest version of the publicized information.

2. The publicized information browsing support system according to claim 1, wherein the output portion outputs a publicized information image of the latest version of the publicized information together with the written image.

3. A publicized information browsing support system for performing a process for allowing one or more users to browse one or more pieces of publicized information each of which is publicized on a network and is to be updated thereon, the publicized information browsing support system comprising:
a storage portion that stores reader information indicating which of the users is to browse attribute information indicating an attribute of at least any one of the one or more pieces of publicized information;
a receiving portion that specifies and receives, at every predetermined timing, the attribute information to be browsed by at least one of the users in accordance with the reader information;
an attribute information output portion that outputs, when one of the users logs onto the publicized information browsing support system, to the one of the users a latest version of the attribute information to be browsed by the one of the users in accordance with the reader information; and
a publicized information output portion that outputs the publicized information specified by the one of the users.

4. A publicized information browsing support method for allowing a user to browse publicized information that is publicized on a network and is to be updated thereon, the method comprising:
causing a system including a communication unit, a printer, an image reading unit, a display, a processor, and a storage to perform:
storing browsing presence/absence information indicating whether or not the user has browsed a latest version of the publicized information,
receiving the publicized information,
printing, onto first paper, a publicized information image representing the publicized information thus received,
reading an image depicted on the first paper,
obtaining a written image that has been added to the first paper after printing the publicized information image by making a comparison between the publicized information image and the image thus read from the first paper,
displaying, as required, the publicized information image together with the written image, or printing, as required, the publicized information image together with the written image onto second paper,
notifying, based on the browsing presence/absence information, the user whether or not the user has browsed the latest version of the publicized information,
receiving, at every predetermined timing, update date and time information indicating an update date and time on which the publicized information has been updated,
updating, when the publicized information image has been outputted to the user, the browsing presence/absence information in such a manner to indicate that the user has browsed the latest version of the publicized information, and
updating, when the publicized information is determined to have been updated based on the update date and time indicated in the update date and time information thus received, or when the written image has been obtained, the browsing presence/absence information in such a manner to indicate that the user has not browsed the latest version of the publicized information.

5. A publicized information browsing support method for allowing one or more users to browse one or more pieces of publicized information each of which is publicized on a network and is to be updated thereon, the publicized information browsing support method comprising:
causing a system including a communication unit, an image reading unit, either one of a printer and a display, a processor, and a storage to perform:
storing reader information indicating which of the users is to browse attribute information indicating an attribute of at least any one of the one or more pieces of publicized information,
specifying and receiving, at every predetermined timing, the attribute information to be browsed by at least one of the users in accordance with the reader information,
displaying or printing onto paper, when one of the users logs onto the system, a latest version of the attribute information to be browsed by the one of the users in accordance with the reader information, and displaying or printing onto paper the publicized information specified by the one of the users.

6. A computer-readable storage medium storing thereon a computer program for controlling an image processing apparatus comprising a communication unit, a printer, an image reading unit, a display, a processor, and a storage, the computer program causing the image processing apparatus to perform:
storing browsing presence/absence information indicating whether or not a user has browsed a latest version of publicized information that is publicized on a network and is to be updated thereon;
receiving the publicized information;
printing, onto first paper, a publicized information image representing the publicized information thus received;
reading an image depicted on the first paper;
obtaining a written image that has been added to the first paper after printing the publicized information image by making a comparison between the publicized information image and the image thus read from the first paper;
displaying, as required, the publicized information image together with the written image, or printing, as required, the publicized information image together with the written image onto second paper;
notifying, based on the browsing presence/absence information, the user whether or not the user has browsed the latest version of the publicized information;
receiving, at every predetermined timing, update date and time information indicating an update date and time on which the publicized information has been updated;
updating, when the publicized information image has been outputted to the user, the browsing presence/absence information in such a manner to indicate that the user has browsed the latest version of the publicized information; and
updating, when the publicized information is determined to have been updated based on the update date and time indicated in the update date and time information thus received, or when the written image has been obtained, the browsing presence/absence information in such a manner to indicate that the user has not browsed the latest version of the publicized information.

7. A computer-readable storage medium storing thereon a computer program for controlling an image processing apparatus comprising a communication unit, an image reading unit, either one of a printer and a display, a processor, and a storage, the computer program causing the image processing apparatus to perform:
storing reader information indicating which of one or more users is to browse attribute information indicating an attribute of at least any one of one or more pieces of publicized information that is publicized on a network and is to be updated thereon;
specifying and receiving, at every predetermined timing, the attribute information to be browsed by at least one of the users in accordance with the reader information;
displaying or printing onto paper, when one of the users logs onto the image processing apparatus, a latest version of the attribute information to be browsed by the one of the users in accordance with the reader information; and
displaying or printing onto paper the publicized information specified by the one of the users.
